(19) United States
(12) Patent Application Publication
(10) Pub. No.: US 2003/0020668 A1
(43) Pub. Date: Jan. 30, 2003

(54) Broadband polling structure

(76) Inventor: George Earl Peterson, Warren, NJ (US)

Correspondence Address: Michael J. Urbano, Esq., 1445 Princeton Drive, Bethlehem, PA, 18017-9166, US

(21) Appl. No.: 09/915,963

(22) Filed: Jul. 26, 2001

(51) Int. Cl. H01Q 1/48; H01Q 1/50

(52) U.S. Cl. 343/846; 343/850

(57) ABSTRACT

An antenna structure including at least one antenna element having at least one taper. The taper selected from the group comprising a linear profile, a linear constant profile, a broken-linear profile, an exponential profile, an exponential constant profile, a tangential profile, a step-constant profile, or a parabolic profile. The antenna structure also including a symmetrical ground plane, which is coupled with the antenna element.

### FIELD OF THE INVENTION

The present invention relates to antenna structures.

### BACKGROUND OF THE INVENTION

Demand for broadband applications employing an increasingly wide range of operable frequencies is growing. These broadband applications have, to date, required antenna structures including a number of independent antenna elements. Each antenna element in such an antenna structure is designated to radiate and/or capture electromagnetic energy within a relatively narrow frequency band from the range of operable frequencies employed. Consequently, a considerable number of antenna elements have been used in broadband applications to radiate and/or capture electromagnetic energy over the entire range of operable frequencies, thereby adding to the size and complexity of the antenna structure.

Various alternatives have been proposed to reduce the size and complexity of antenna structures used in broadband applications. One such alternative being explored is tapered slot antennas. Tapered slot antennas operate (e.g., radiate and/or capture electromagnetic energy) over a frequency spectrum ranging from about 900 MHz to well over 10 GHz. To support this wide range of operative frequencies, a tapered slot antenna includes an expanding slot transmission line formed on a dielectric substrate, thereby creating a balanced impedance. A balanced impedance may be characterized by a pair of conductors, in the presence of a ground, which support the propagation of a balanced signal therethrough. A balanced signal includes a pair of symmetrical signals, which are equal in magnitude and opposite in phase.

While operating over a wide frequency spectrum, tapered slot antennas are known to provide narrow directivity. The directivity of an antenna may be defined as the ratio of the radiation intensity in a given direction from the antenna to the radiation intensity averaged over all directions. Directivity may also be characterized as the directional beam pattern of the electromagnetic energy radiated and/or captured by an antenna. For example, the directivity of a tapered slot antenna may be characterized as having a cigar-like directional beam pattern.

Tapered slot antennas are endfire-type devices, having a narrow directional beam pattern emanating from the exposed end of the antenna's dielectric substrate. Consequently, tapered slot antennas have been unsuitable for a number of broadband applications, such as in a radio frequency identification (“RFID”) polling system, requiring wider directivity than endfire-type devices. For these types of broadband applications, traditional multi-element antenna structures have been used to date.

### SUMMARY OF THE INVENTION

I have invented an antenna structure, which operates over a wide frequency spectrum and offers wider directivity than endfire-type devices. I have recognized that the narrow directivity of tapered slot antennas is attributable to the phase velocity supported by antenna's dielectric substrate. In accordance with the present invention, my antenna structure supports a phase velocity greater than the speed of light. In one embodiment of the present invention, an antenna structure comprises a tapered antenna element coupled with a symmetrically shaped ground plane. The tapered antenna element is positioned at an angle from ground plane, which may advantageously be 90 degrees.

### BRIEF DESCRIPTION OF THE DRAWINGS

The present invention will be better understood from reading the following description of non-limiting embodiments, with reference to the attached drawings, wherein below:

FIG. 1 is a perspective view of a known antenna structure;

FIG. 2(a) is a perspective view, while FIG. 2(b) is a cross-sectional view of an embodiment of the present invention;

FIGS. 3(a) through 3(h) are side views of examples of a feature of the present invention; and

FIG. 4(a) is a perspective view, while FIG. 4(b) is a top view of an example of the present invention.

It should be emphasized that the drawings of the instant application are not to scale but are merely representations and thus are not intended to portray the specific parameters or the structural details of the invention, which may be determined by one of skill in the art by examination of the information contained herein.

### DETAILED DESCRIPTION

Tapered slot antennas belong to a class of planar, endfire-type devices commonly referred to as travelling wave antennas. Travelling wave antennas are known to offer a wide operative frequency range (from about 900 MHz to about 90 GHz) and high gain (from about 7 to 10 dB). However, travelling wave antennas also have limited directivity. More particularly, travelling wave antennas demonstrate relatively narrow symmetrical E- and H- plane directional beam patterns.

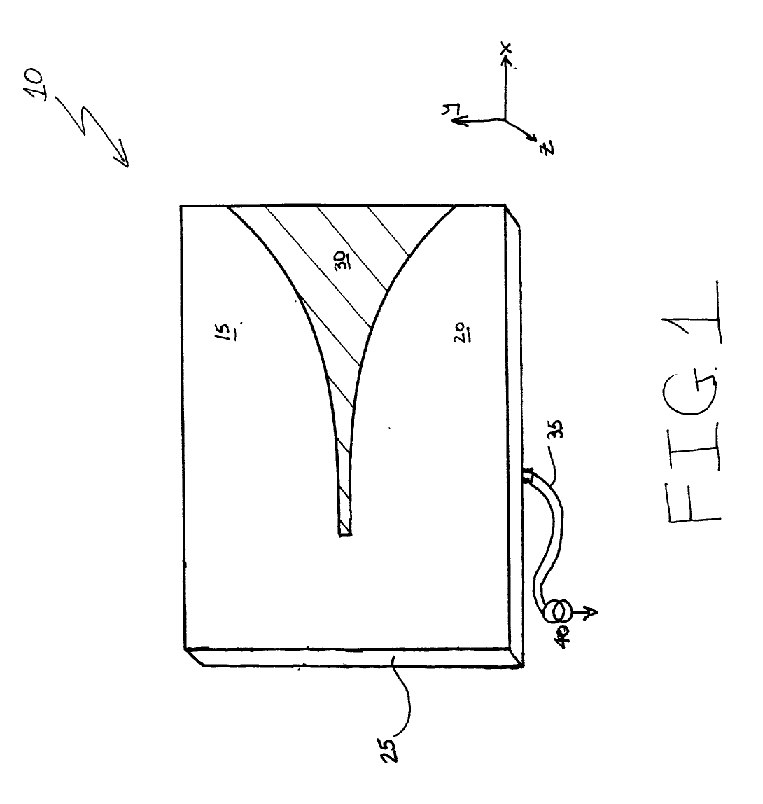

Referring to FIG. 1, a perspective view of a known tapered slot antenna 10 is shown. Tapered slot antenna 10 has a balanced configuration, realized by an expanding slotted transmission line. More particularly, tapered slot antenna 10 comprises a first and a second conductive film or leaf, 15 and 20, formed on a substrate 25. First and second conductive leaves, 15 and 20, support the propagation of balanced signals therethrough—i.e., a symmetrical pair of signals which are equal in magnitude and opposite in phase. Moreover, first and second leaves, 15 and 20, are defined by an expanding tapered slot 30. Expanding tapered slot 30 exposes the upper surface of substrate 25 and its dielectric characteristics. By this arrangement, tapered slot antenna 10 has a planar, travelling wave design, radiating and/or capturing electromagnetic energy from an exposed end of substrate 25—i.e., in the direction of the x-axis.

Coupled with tapered slot antenna 10 is an unbalanced impedance 35. Unbalanced impedance 35 comprises a first conductor for supporting the propagation of unbalanced (i.e., asymmetrical) signals therethrough with respect to a second conductor (i.e., ground). Unbalanced impedance 35 commonly comprises a coaxial cable, though various substitutes and alternatives may also be employed. For the purposes of illustration, unbalanced impedance 35 is coupled with a radio frequency device 40, such as a receiver, transmitter or transceiver.

Tapered slot antenna 10 couples first and second conductive leaves, 15 and 20, with unbalanced impedance 35 by means of various means, including a balun (not shown), for example. Alternatives to the balun are disclosed in co-pending patent application, Ser. No. 09/836,024, filed on Apr. 17, 2001, commonly assigned with the present invention, hereby incorporated by reference. The balun and these alternatives convert a balanced signal propagating through first and second conductive leaves, 15 and 20, to an unbalanced signal for unbalanced impedance 35, and vice versa.

Tapered slot antenna 10 transforms electromagnetic energy from a guided wave into a plane wave propagating through free space. A continuous interaction between the guided wave and the plane wave may only be maintained if the free space wavelength, λ₀, and the guided wavelength, λ_{g}, satisfy the following mathematical relationship:

λ₀=λ_{g}* cosΘ

where Θ is an angle from the x- axis in which electromagnetic energy is radiated or captured. The direction of the electromagnetic energy radiated or captured by tapered slot antenna 10 is determined by the Poynting vector, E×H, which is defined by the electromagnetic field distributions along antenna 10. The total field may be viewed as a combination of six field components corresponding with the dielectric-to-air interface in tapered slot antenna 10.

The directivity of tapered slot antenna 10 is affected by the characteristics of substrate 25. More particularly, the dielectric characteristics of substrate 25 are a function of its geometrical parameters (e.g., length, width and thickness), as well as the taper profile of expanding tapered slot 30. Consequently, the geometrical parameters and taper profile influence the directivity, and thusly the E- and H- plane directional beam patterns of tapered slot antenna 10.

Tapered slot antenna 10 may be modeled using the wave phenomenon theory. A wave propagating in a non-dispersive medium may be characterized by the following relationship:

k=ω√μ*ε=ω/νₚ

where k is the wavenumber, μ is the permeability and ε is the permittivity of the non-dispersive medium, respectively. From the above dispersive mathematical relationship, a wave propagating in free space may be stated as follows:

k₀=ω√μ₀*ε₀=ω/c

where k₀ is the wavenumber, μ₀ is the permeability and ε₀ is the permittivity of free space. The directivity of an endfire travelling wave antenna may be derived from the above dispersive equations, and restated by following equation:

k=k₀+π/L

where L is the length of the endfire travelling wave antenna. This equation forms the basis of the Hansen-Woodyard condition. The Hansen-Woodyard condition has shown that the directivity of an antenna is maximized if the wavenumber, k, satisfies the above equation. According to the Hansen-Woodyard condition, the directivity of the antenna may be increased by slowing the propagation of the wave guided by the radiating structure (e.g., non-dispersive medium). Consequently, the Hansen-Woodyard condition concludes that the directivity of a travelling wave antenna is in the endfire direction (x- axis) having a beam pattern of electromagnetic energy with a relatively finer main lobe. It has been experimentally observed that a tapered slot antenna having a length, L, between 4*λ₀ and 10*λ₀, where λ₀ is the free space wavelength, and a substrate thickness between 0.003*λ₀ and 0.01*λ₀, generally exhibits standard travelling-wave characteristics of broad bandwidth and low side lobe field intensity characteristics. For more information, see Lee and Chen, “Advances in Microstrip and Printed Antennas,” John Wiley & Sons 1997, pp. 443-513. Since travelling wave antennas have a narrow directivity, it is unsuitable for a number of broadband applications, including radio frequency identification (“RFID”) polling systems, for example, which require wider directivity than endfire-type devices, such as tapered slot antenna 10, to determine the location and status information of a corresponding unit transponder within a large enclosed area.

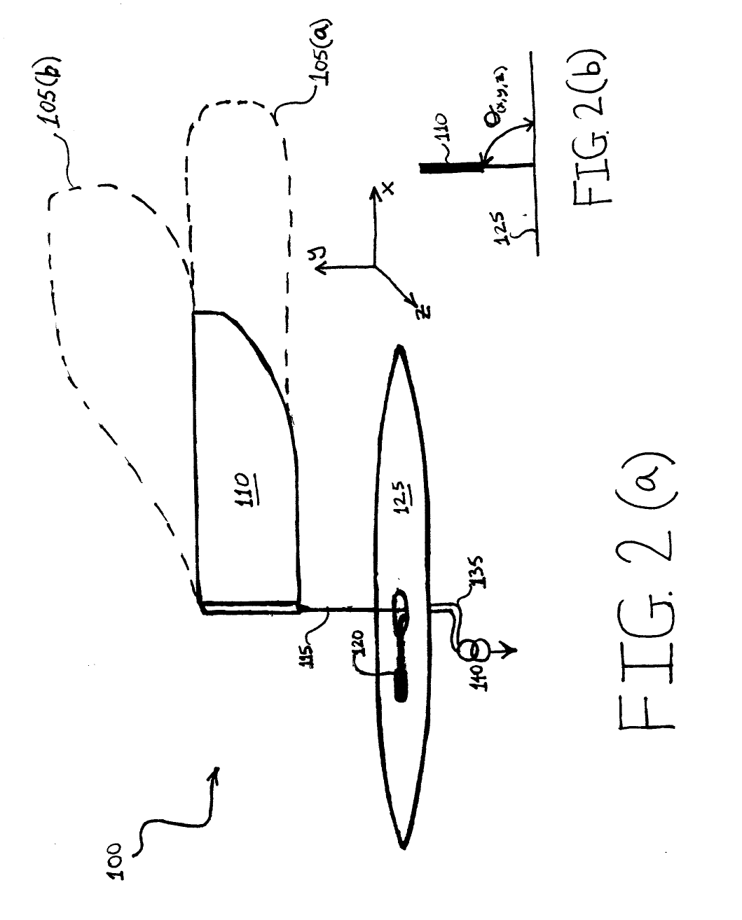

Referring to FIGS. 2(a) and 2(b), an embodiment of the present invention is shown. Here, a broadband antenna structure 100 is depicted having wider directivity than tapered slot antenna 10 of FIG. 1. Broadband antenna structure 100 supports a phase velocity greater than the speed of light, and comprises an antenna “flag” element 110 for radiating and/or capturing electromagnetic energy over a wide frequency range. Antenna “flag” element 110 comprises a conductor, such as aluminum or copper, for example.

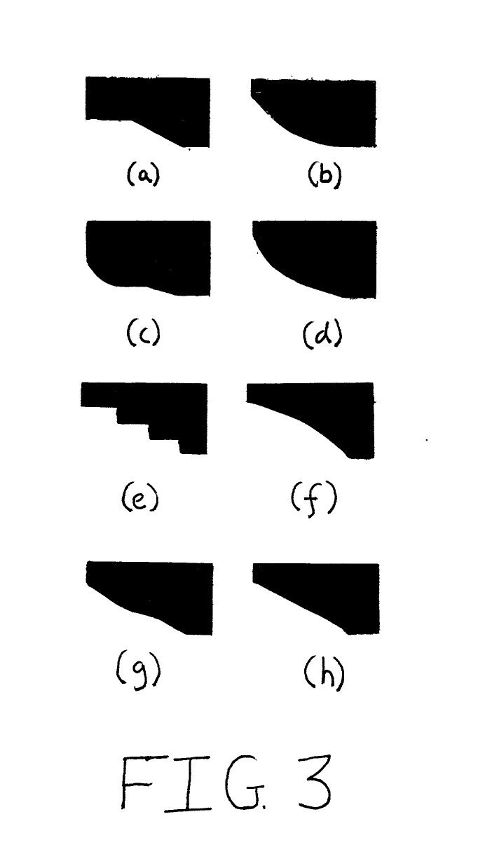

Antenna element 110 has a taper, described in detail hereinbelow in accordance with FIGS. 3(a) through 3(h). This taper affords broadband antenna structure 100 a wide frequency bandwidth, much like tapered slot antenna 10 of FIG. 1. In one example of the present invention, antenna “flag” element 110 has a frequency range of about 900 MHz to about 4 GHz. The taper of antenna “flag” element 110 also affords broadband antenna 100 relatively wider directivity.

Broadband antenna structure 100 also comprises a ground plane 125. Ground plane 125 comprises a symmetrical shape to support the relatively wider directivity of broadband antenna structure 100. Advantageously, ground plane 125 has a disk-like shape, though other symmetrical shapes may also be employed in conjunction with the present invention.

Coupled with broadband antenna structure 100 is an unbalanced impedance 135. Unbalanced impedance 135 comprises a first conductor 115 for supporting the propagation of unbalanced (i.e., asymmetrical) signals therethrough with respect to a second conductor 120, which is electrically coupled with ground plane 125. It should be noted that first conductor 115 also provide mechanical support for antenna “flag” element 110.

Unbalanced impedance 135 commonly comprises a coaxial cable—particularly with respect to wireless and radio frequency devices. Unbalanced impedance 135, however, may be realized by various substitutes and alternatives. As shown, unbalanced impedance 135 is coupled with a radio frequency device 140, such as a receiver, transmitter or transceiver. It will be apparent to skilled artisans upon reviewing the instant disclosure that various alternatives may be employed for coupling broadband antenna structure 100 with radio frequency device 140, such as those detailed in co-pending patent application, Ser. No. 09/836,024, filed on Apr. 17, 2001, commonly assigned with the present invention.

Broadband antenna structure 100 has relatively wider directivity than tapered slot antenna 10 of FIG. 1. Tapered slot antenna 10 has a cigar-like directional beam pattern 105(a) in the x-, y-, and z- directions. Broadband antenna 100 supports side lobes with a butterfly wing-like directional beam pattern 105(b) in the x-, y-, and z- directions. Butterfly wing-like directional beam pattern 105(b) is supported by the taper of antenna “flag” element 110 and the symmetrical shape of ground plane 125. Antenna “flag” element 110 is at an angle, Φ_{x,y,z}, with respect to the x-, y- and z- axes. Advantageously, angle, Φ_{x,y,z}, is about 90 degrees to support the widest available directivity for broadband antenna structure 100. Consequently, with the addition of directional beam pattern 105(b) the directivity of antenna element 110 no longer corresponds with merely endfire-type devices, such as tapered slot antenna 10.

Referring to FIGS. 3(a) through 3(h), side views of examples of the various tapers available for antenna “flag” element 110 of FIGS. 2(a) and 2(b) are shown. With respect to FIG. 3(a), the taper for antenna “flag” element 110 is referred to as a linear constant profile. The taper of FIG. 3(b) is referred to as an exponential profile. FIG. 3(c) illustrates a taper having an exponential constant profile, while FIG. 3(d) depicts a taper having a tangential profile. The taper of FIG. 3(e) is commonly referred to as a step-constant profile, while the taper of FIG. 3(f) is commonly referred to as parabolic profile. FIG. 3(g) illustrates a taper having a broken-linear profile, and FIG. 3(h) depicts a taper having a linear profile. Although a number of tapers are illustrated in FIGS. 3(a) through 3(h), various alternatives apparent to skilled artisans upon reviewing the instant disclosure are also contemplated herein.

The dimensions of each taper principally affect the response characteristics (e.g., frequency range and directivity) of broadband antenna 100. These dimensions are measured relative to the taper. Consequently, the length of the antenna “flag” element 110, for example, as well as the width of the deviation from the normal of the antenna “flag” element 110 both affect the response characteristics of broadband antenna structure 100. Similarly, the contour of the taper chosen also has an influence on the response characteristics of broadband antenna 100.

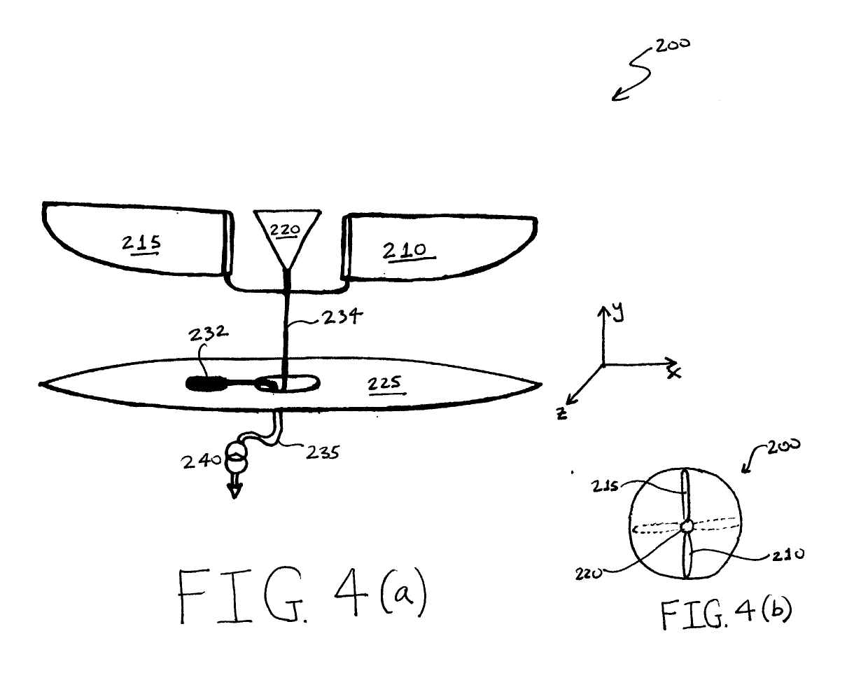

Referring to FIGS. 4(a) and 4(b), an example of the present invention is shown. More particularly, a broadband antenna arrangement 200 is illustrated for providing a sufficiently wide directivity to scan a three- dimensional area. Antenna structures supporting directivities capable of scan three- dimensional space are of interest in polling applications, such as radio frequency identification systems. For example, in a radio frequency identification system, one design would be to place broadband antenna arrangement 200 on top of a ceiling of a large enclosed area to determine the location and status information of a corresponding unit transponder therein. It will be apparent to skilled artisans, however, upon reviewing the instant disclosure that broadband antenna arrangement 200 may also be useful in various other applications, including radar systems and a number of wireless cellular applications.

Broadband antenna arrangement 200 comprises a ground plane 225. Ground plane 225 comprises a symmetrical shape to support the relatively wider directivity of broadband antenna arrangement 200. Advantageously, ground plane 225 has a disk-like shape. Various alternative symmetrical shapes will be apparent to skilled artisans upon reviewing the present disclosure, and may also be employed in conjunction with broadband antenna arrangement 200.

Broadband antenna arrangement 200 also comprises at least two antenna “flag” elements, 210 and 215, for radiating and/or capturing electromagnetic energy over a wide frequency range. Each antenna “flag” element is designed with a taper, much like that of antenna “flag” element 110 of FIGS. 2(a) and 2(b). The taper of each antenna “flag” element, 210 and 215, affords broadband antenna arrangement 200 with a wide frequency bandwidth (e.g., about 900 MHz to about 4 GHz). The taper of each antenna “flag” element, 210 and 215, also affords broadband antenna arrangement 200 with sufficiently wide directivity to poll and/or scan a three- dimensional space. Depending on the accuracy required for polling and/or scanning such a three- dimensional space, a greater number of antenna “flag” elements (e.g., four or more in total) may be required. Each antenna “flag” element, 210 and 215, as such, has fast wave antenna characteristics. Consequently, antenna “flag” elements, 210 and 215, should have a sufficiently close relative proximity with ground plane 225 to cause a fast wave excitation.

Each antenna “flag” element, 210 and 215, supports a complex directivity. The directivity of each antenna “flag” element comprises a cigar-like directional beam pattern in the x-, y-, and z- directions. Moreover, each antenna “flag” element, 210 and 215, supports a butterfly wing-like directional beam pattern (e.g., pattern 105(b) created by antenna “flag” element 110 of FIG. 2(a)) in the x-, y-, and z- directions. By this complex directivity, conical-like directional beam patterns are created by each antenna “flag” element, 210 and 215, to enable the desired three- dimensional space to be polled and/or scanned. Antenna “flag” elements, 210 and 215, are each positioned at an angle, Φ_{x,y,z}, with respect to the x-, y- and z- axes. Advantageously, the angle, Φ_{x,y,z}, of each antenna “flag” element, 210 and 215, is about 90 degrees to support the widest available directivity for broadband antenna arrangement 200.

To insure greater coverage for polling and/or scanning a three-dimensional space, a slow wave antenna element 220 may also be incorporated within broadband antenna arrangement 200. Slow wave antenna element 220 provides a relatively wider directivity than antenna “flag” elements, 210 and 215, and thusly, may have a narrower frequency range than antenna “flag” elements, 210 and 215. Slow wave antenna element 220 may be selected from various known designs, such as a dipole, for example. More particularly, antenna element 220 has slow wave characteristics. Consequently, slow wave antenna element 220 should have a sufficiently greater distance to ground plane 225 than antenna “flag” elements, 210 and 215.

Coupled with broadband antenna arrangement 200 is an unbalanced impedance 235. Unbalanced impedance 235 comprises a first conductor 234 for supporting the propagation of unbalanced (i.e., asymmetrical) signals therethrough with respect to a second conductor 232, which is electrically coupled with ground plane 225. It should be noted that first conductor 234 also provide mechanical support for each antenna “flag” element, 210 and 215.

Unbalanced impedance 235 commonly comprises a coaxial cable—particularly with respect to wireless and radio frequency devices. Unbalanced impedance 235, however, may be realized by various substitutes and alternatives. As shown, unbalanced impedance 235 is coupled with a radio frequency device 240, such as a receiver, transmitter or transceiver. It will be apparent to skilled artisans upon reviewing the instant disclosure that various alternatives may be employed for coupling broadband antenna 100 with radio frequency device 240, such as those detailed in co-pending patent application, Ser. No. 09/836,024, filed on Apr. 17, 2001, commonly assigned with the present invention.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. An antenna structure comprising:
at least one antenna element, the at least one antenna element having at least one taper; and
a symmetrical ground plane coupled with the at least one antenna element.

2. The antenna structure of claim 1, wherein the at least one antenna element comprises a travelling wave antenna supporting a phase velocity greater than the speed of light.

3. The antenna structure of claim 1, wherein the taper comprises a linear profile, a linear constant profile, a broken-linear profile, an exponential profile, an exponential constant profile, a tangential profile, a step-constant profile, or a parabolic profile.

4. The antenna structure of claim 1, wherein the antenna structure supports a cigar-like directional three-dimensional beam pattern and a butterfly wing-like directional three- dimensional beam pattern.

5. The antenna structure of claim 1, wherein the at least one antenna element is positioned at an angle from the symmetrical ground plane.

6. The antenna structure of claim 5, wherein the angle is about 90 degree with respect to the x-, y- and z- axes.

7. The antenna structure of claim 1, wherein the at least one antenna element is coupled with the symmetrical ground plane by means of an unbalanced impedance.

8. The antenna structure of claim 7, wherein the unbalanced impedance comprises a coaxial cable.

9. The antenna structure of claim 7, wherein a first conductor of the unbalanced impedance mechanically couples the at least one antenna element with the symmetrical ground plane.

10. The antenna structure of claim 1, wherein the symmetrical ground plane is disk shaped.

11. An antenna structure comprising:
an array of at least two antenna elements, each antenna element having at least one taper;
a symmetrical ground plane; and
an unbalanced impedance for coupling the array of at least two antenna elements with the symmetrical ground plane.

12. The antenna structure of claim 11, wherein at least one antenna element of the array comprises a travelling wave antenna supporting a phase velocity greater than the speed of light.

13. The antenna structure of claim 11, wherein the taper of at least one antenna element of the array comprises a linear profile, a linear constant profile, a broken-linear profile, an exponential profile, an exponential constant profile, a tangential profile, a step-constant profile, or a parabolic profile.

14. The antenna structure of claim 11, wherein each antenna element of the array supports a cigar-like directional three-dimensional beam pattern and a butterfly wing-like directional three- dimensional beam pattern.

15. The antenna structure of claim 11, wherein each antenna element of the array is positioned at an angle from the symmetrical ground plane.

16. The antenna structure of claim 15, wherein the angle for each antenna element is about 90 degree with respect to the x-, y- and z- axes.

17. The antenna structure of claim 11, wherein the unbalanced impedance comprises a coaxial cable.

18. The antenna structure of claim 17, wherein a first conductor of the unbalanced impedance mechanically couples each antenna element of the array with the symmetrical ground plane.

19. The antenna structure of claim 11, wherein the symmetrical ground plane is disk shaped.

20. The antenna structure of claim 11, further comprising a slow wave antenna to widen the directivity of the antenna structure.

21. An apparatus comprising:
a transceiver; and
an antenna structure for radiating or capturing electromagnetic energy from or to the transceiver comprising:
at least one antenna element having at least one taper, the taper comprising a linear profile, a linear constant profile, a broken-linear profile, an exponential profile, an exponential constant profile, a tangential profile, a step-constant profile, or a parabolic profile;
a symmetrical disk shaped ground plane, the at least one antenna element being positioned at an angle from the symmetrical disk shaped ground plane; and
an unbalanced impedance for coupling the at least one antenna element with the symmetrical disk shaped ground plane.

22. The apparatus of claim 21, wherein the at least one antenna element supports a cigar-like directional three-dimensional beam pattern and a butterfly wing-like directional three- dimensional beam pattern.

23. The antenna structure of claim 21, wherein the angle is about 90 degree with respect to the x-, y- and z- axes.

24. The antenna structure of claim 21, wherein the unbalanced impedance comprises a coaxial cable.

25. The antenna structure of claim 21, wherein a first conductor of the unbalanced impedance mechanically couples the at least one antenna element with the symmetrical ground plane.
